(19) United States
(12) Patent Application Publication
(10) Pub. No.: US 2019/0345275 A1
(43) Pub. Date: Nov. 14, 2019

(54) POLYVINYL ACETAL RESIN COMPOSITION, INTERLAYER FOR LAMINATED GLASS COMPRISING THE SAME, AND LAMINATED GLASS

(71) Applicant: SKC Co., Ltd., Suwon-si (KR)

(72) Inventors: Hyejin Kim, Suwon-si (KR); Kyuhun Kim, Seoul (KR); JiYeon Ryu, Suwon-si (KR); Jewon Yeon, Suwon-si (KR); Hak Soo Lee, Suwon-si (KR); Sung Jin Chung, Seoul (KR)

(73) Assignee: SKC Co., Ltd., Suwon-si (KR)

(21) Appl. No.: 16/223,298

(22) Filed: Dec. 18, 2018

(30) Foreign Application Priority Data
May 8, 2018 (KR) 10-2018-0052335

(51) Int. Cl. C08F 16/38; B32B 17/10; B32B 27/08; B32B 27/30; C08J 5/18; C08K 5/103

(52) U.S. Cl. CPC C08F 16/38; B32B 17/10036; B32B 17/10761; B32B 27/08; C08J 2329/14; C08J 5/18; C08K 5/103; B32B 2419/00; B32B 2605/006; B32B 27/30

(57) ABSTRACT

A polyvinyl acetal resin composition includes a polyvinyl acetal, an aldehyde, and an alkanol, wherein the alkanol is present in an amount of 50 parts by weight or more with respect to 100 parts by weight of the aldehyde.

### CROSS-REFERENCE TO RELATED APPLICATION

This application claims the benefit under 35 USC 119(a) of Korean Patent Application No. 10-2018-0052335, filed on May 8, 2018, the entire disclosure of which is incorporated herein by reference for all purposes.

### BACKGROUND

### 1. Field

The present disclosure relates to a polyvinyl acetal resin composition, an interlayer for laminated glass which comprises a polyvinyl acetal resin composition, and laminated glass, which comprises an interlayer comprising a polyvinyl acetal resin composition.

### 2. Description of the Background

Generally, laminated glass (e.g., tempered glass and safety glass) comprises a pair of glass panels and a synthetic resin film inserted therebetween. Since laminated glass prevents sharp glass fragments from being scattered from the laminated glass even though the laminated glass has broken, laminated glass is considered to have excellent safety performance and thus, is widely used in window glass of vehicles such as automobiles and window glass of buildings.

Polyvinyl acetal resins are prepared by acetalization of polyvinyl alcohol and an aldehyde, or the like. To enhance production efficiency of such a polyvinyl acetal resin in industrial processes, excess amounts of reactants are added with respect to the stoichiometric amount. Therefore, unnecessary byproducts may be formed.

However, these byproducts could affect performance of synthetic resin films such as color, durability, and the like. Thus, it may be important to effectively remove these byproducts. Japanese Patent Application Registration No. 5588091 (Polyvinyl Acetal Resin and Preparation Method Thereof) discloses a process of heat-treating a resin slurry, and Japanese Patent Application Registration No. 5926602 (Method of Preparing Polyvinyl Acetal Resin and Polyvinyl Acetal Resin) discloses a method of specifying the concentration of hydrogen ions of an acid catalyst and performing acetalization at high temperature and high pressure.

The above information is presented as background information only to assist with an understanding of the present disclosure. No determination has been made, and no assertion is made, as to whether any of the above might be applicable as prior art with regard to the disclosure.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a polyvinyl acetal resin composition includes a polyvinyl acetal, an aldehyde, and an alkanol, wherein the alkanol is present in an amount of 50 parts by weight or more with respect to 100 parts by weight of the aldehyde.

The aldehyde may include n-butanal, and the alkanol may include 2-ethylhexanol.

The 2-ethylhexanol may be present in an amount of about 0.5 to about 4 parts by weight, with respect to 1 part by weight of the n-butanal.

The polyvinyl acetal may be prepared by acetalization of polyvinyl alcohol and the aldehyde.

The polyvinyl acetal may be a first polyvinyl acetal having a hydroxyl content of 30 mol % or more and an acetyl content of less than 2 mol %.

The hydroxyl content of the first polyvinyl acetal may be in a range from about 30 mol % to about 50 mol %.

The polyvinyl acetal may be a second polyvinyl acetal having a hydroxyl content of 40 mol % or less and an acetyl content of 8 mol % or more.

The hydroxyl content of the second polyvinyl acetal may be in a range from about 1 mol % to about 10 mol %.

In another general aspect, an interlayer for laminated glass includes a first layer including a first polyvinyl acetal, an aldehyde, a reaction product derived from the aldehyde, and a plasticizer, wherein the reaction product derived from the aldehyde includes an alkanoic acid in an amount of 2.0 wt % or less with respect to a total amount of a reference material, which is the aldehyde and the reaction product of the aldehyde.

The first layer may include an alkanol as the reaction product.

The first layer may have a yellowness index of 3.0 or less. The yellowness index may be based on measurement made in accordance with ASTM E313-15e1.

The reference material may include any one selected from the group consisting of i) n-butanal; ii) 2-ethylhexanoic acid; iii) any one selected from the group consisting of 2-ethyl-2-hexanal, 2-ethylhexanal, 2-ethylhexanol; and combinations thereof.

A laminated glass may include a laminated structure including a first glass disposed on a surface of the interlayer and a second glass disposed on another surface of the interlayer.

The interlayer may further include a second layer including a second polyvinyl acetal. The first polyvinyl acetal may include a hydroxyl content of 30 mol % or more and an acetyl content of less than 2 mol %, and the second polyvinyl acetal may include a hydroxyl content of 40 mol % or less and an acetyl content of 8 mol % or more.

In another general aspect, a laminated glass includes an interlayer including a first layer, a first glass disposed on a surface of the interlayer and a second glass disposed on an opposite surface of the interlayer, wherein the first layer comprises a first polyvinyl acetal, an aldehyde, and an alkanol, wherein the alkanol is present in an amount of 50 parts by weight or more with respect to 100 parts by weight of the aldehyde.

The interlayer may further include a plasticizer and the first layer may include about 58 to about 80 parts by weight of the first polyvinyl acetal and about 20 to about 42 parts by weight of the plasticizer, and the second layer may include about 58 to about 69 parts by weight of the second polyvinyl acetal and about 31 to about 42 parts by weight of the plasticizer.

The laminated glass may further include a difference in yellowness index d−YI of 3 or less, where YI_{final} is a yellowness index final value after an accelerated weathering test for at least 740 hours of the laminated glass performed in accordance with KS M ISO 4892-3:2002, YIᵢₙᵢₜᵢₐₗ is a yellowness index initial value before the weathering test, and d−YI=YI_{final}−YIᵢₙᵢₜᵢₐₗ, wherein the yellowness indices YIᵢₙᵢₜᵢₐₗ and YI_{final} are measured in accordance with ASTM E313 standard.

Other features and aspects will be apparent from the following detailed description, the drawings, and the claims.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. Hereinafter, while embodiments of the present disclosure will be described in detail with reference to the accompanying drawings, it is noted that examples are not limited to the same.

As used herein, the terms “about,” “substantially,” and the like, which indicate degrees, are used to mean a numerical value or a value approximating the numerical value when manufacturing errors and material-allowable errors specific to the mentioned meaning are given, and are used to prevent an unconscientious infringer from improperly using the disclosed details that mention accurate or absolute numerical values to aid in understanding the present disclosure.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “combination(s) thereof” from the Markush type means a mixture or combination of one or more elements selected from the group consisting of elements described in the expression of the Markush type.

As used herein, the term “and/or” includes any one and any combination of any two or more of the associated listed items; likewise, “at least one of” includes any one and any combination of any two or more of the associated listed items.

Although terms such as “first,” “second,” and “third” or “A” and “B” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “higher,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” “upper,” or “higher” relative to another element will then be “below” or “lower” relative to the other element. Thus, the term “above” encompasses both the above and below orientations depending on the spatial orientation of the device and the term “higher” encompasses both the higher and lower orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

Herein, it is noted that use of the term “may” with respect to an example, for example, as to what an example may include or implement, refers to at least one example in which such a feature is included or implemented while all examples are not limited thereto.

One or more embodiments of a polyvinyl acetal resin composition having a lower Yellow Index and enhanced durability compared to conventional polyvinyl acetal film is described, and one or more embodiments of a laminated glass including an interlayer of a polyvinyl acetal resin composition having a lower Yellow Index and enhanced durability compared to conventional polyvinyl acetal film is also described.

In an effort to reduce a yellowing phenomenon of a polyvinyl acetal film and enhancing durability of the film, the inventors of the present application discovered that a trace amount of acid material affected the occurrence of yellowing and reduced durability in a process of extruding a polyvinyl acetal film at a relatively high temperature, identified this acid material, and discovered a method of reducing the acid material as disclosed in the one or more embodiments described herein.

In addition, the inventors of the present application discovered that the amount of acid material (e.g., alkanoic acid) in the polyvinyl acetal film formed could be adjusted by controlling the amount of an alkylalcohol remaining in a resin in a process of synthesizing a polyvinyl acetal resin, therefore a degree of yellowing and durability of the film could be improved as disclosed in the one or more embodiments described herein.

According to one or more embodiments, a polyvinyl acetal resin composition may include a polyvinyl acetal, an aldehyde, and an alkanol, wherein the alkanol may be present in an amount of 50 parts by weight or more with respect to 100 parts by weight of the aldehyde in the composition.

The aldehyde included in the composition may be a residual aldehyde after acetalization of polyvinyl alcohol and the aldehyde.

The alkanol may include an alkanol derived from the residual aldehyde.

The aldehyde may have a formula represented by R₁CHO, wherein R₁ is hydrogen or propyl.

The alkanol may have a formula represented by R₂CH₂OH, wherein R₂ is methyl or ethylpentyl.

The alkanol may be present in an amount of about 50 to about 10,000 parts by weight with respect to 100 parts by weight of the aldehyde in the composition.

For example, the alkanol may be present in an amount of about 50 to about 400 parts by weight with respect to 100 parts by weight of the aldehyde.

For example, the alkanol may be present in an amount of about 70 to about 200 parts by weight with respect to 100 parts by weight of the aldehyde.

When the polyvinyl acetal resin composition comprising an alkanol and an aldehyde in amounts within the above ranges is applied to film preparation, the alkanol having a relatively low boiling point is easily removed in a process of preparing a polyvinyl acetal film, which is performed at a relatively high temperature, and a polyvinyl acetal film with little or almost no acid component comprised therein may be prepared.

The aldehyde applied to synthesis of the polyvinyl acetal may be any one selected from the group consisting of n-butyl aldehyde (n-butanal), isobutyl aldehyde, n-barrel aldehyde, 2-ethyl butyl aldehyde, n-hexyl aldehyde, and combinations thereof. For example, n-butanal may be used as the aldehyde to prepare polyvinyl butyral. When the Polyvinyl butyral resin is used in an interlayer for glass lamination, a difference in refractive index between glass and the film that are bonded together is small and the film has excellent adhesion to the glass.

To enhance production efficiency in an industrial process of synthesizing a polyvinyl acetal, an aldehyde is added in excess amount of the stoichiometric proportions. Thus, the aldehyde remains after the reaction and undergoes an aldol condensation reaction, reduction, oxidation, and the like. As a result, aldehyde-derived reaction products are formed with a polyvinyl acetal resin and may be comprised in a polyvinyl acetal resin composition. In addition, among these reaction products, particularly an acid material may induce a yellowing phenomenon or durability deterioration of a polyvinyl acetal film.

Although various attempts have been made to control an absolute amount of an acid material comprised in the polyvinyl acetal resin composition using a method such as washing or the like, a yellowing phenomenon of the fabricated film occurs or durability thereof is reduced.

Thus, in the present disclosure, by controlling relative amounts of components comprised in the polyvinyl acetal resin composition, deterioration of color and durability of the polyvinyl acetal film may be minimized although the residual aldehyde such as extra butanal or the like is present in the synthesized polyvinyl acetal resin.

That is, in the present disclosure, a polyvinyl acetal resin composition comprising a relatively large content of an alkanol compared to that of an aldehyde is prepared through a post-treatment process which comprises a reduction reaction step of the residual aldehyde and a reaction product thereof, with applying a catalyst, a reducing atmosphere, or the like.

The reduction reaction step comprised in the post-treatment process may be performed in the presence of a catalyst, and the catalyst may be, in particular, a copper chromite catalyst, a nickel catalyst, or a rhodium catalyst, but the present disclosure is not limited thereto.

The reduction reaction step comprised in the post-treatment process may be performed in a reducing atmosphere, and may be performed, for example, in a hydrogen-nitrogen atmosphere and at high temperature and high pressure. In particular, the reduction reaction step may be performed at a reaction temperature of about 140 to about 200° C. and a reaction pressure of about 5 to about 30 bara (absolute pressure).

When these catalyst conditions and these high-temperature and high-pressure conditions are applied to the post-treatment process, manufacturing efficiency may be further enhanced.

In particular, when n-butanal (Formula 1 below) is used as the aldehyde, reaction products of the residual aldehyde after resin synthesis may be represented by Formulae 2 to 5 below:

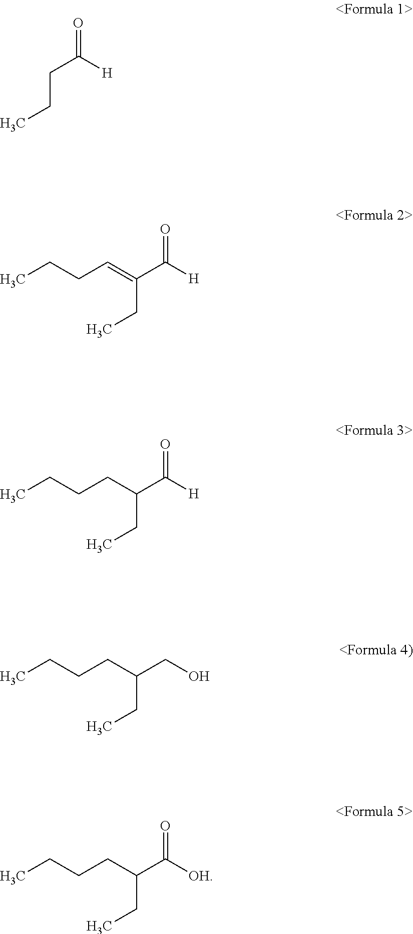

Among the above reaction products, 2-ethylhexanoic acid (Formula 5), which is an alkanoic acid, is an acid material and is generated by oxidation of 2-ethylhexanal (Formula 3), which is one of the reaction products derived from the aldehyde of Formula 1. On the other hand, 2-ethylhexanol (Formula 4), which is an alkanol, is generated by reduction of the 2-ethylhexanal (Formula 3).

The polyvinyl acetal resin composition of the present disclosure may comprise n-butanal as the aldehyde and 2-ethylhexanol as the alkanol.

The amount of the 2-ethylhexanol in the polyvinyl acetal resin composition may be 0.5 parts by weight or more, may be about 0.5 to about 4 parts by weight, may be about 0.6 to about 3 parts by weight, or may be about 0.7 to about 2 parts by weight, with respect to 1 part by weight of the n-butanal.

When the polyvinyl acetal resin composition has the above properties, the reaction products of the residual aldehyde are finally obtained in a reduced form rather than in an oxidized form, and thus an acid component is produced at a very low level and the reduced reaction products having a relatively low boiling point are produced. These reduced reaction products are easily removed into the air in a film preparation process, which is performed at a high temperature, and accordingly, the amount of acid component in the prepared polyvinyl acetal resin composition is very small, and a polyvinyl acetal film with enhanced durability may be prepared.

The polyvinyl acetal may be a polyvinyl acetal obtained by acetalizing polyvinyl alcohol having a degree of polymerization of about 1,600 to about 3,000 with an aldehyde.

The polyvinyl acetal resin may be a first polyvinyl acetal having a hydroxyl content of 30 mol % or more and an acetyl content of less than 2 mol %, and the hydroxyl content of the first polyvinyl acetal may range from about 30 mol % to about 50 mol %. The polyvinyl acetal resin having these properties may be used to manufacture a polyvinyl acetal film having excellent adhesion to glass and excellent mechanical strength.

The polyvinyl acetal resin may be a second polyvinyl acetal having a hydroxyl content of 40 mol % or less and an acetyl content of 8 mol % or more, and the hydroxyl content of the second polyvinyl acetal resin may range from about 1 mol % to about 10 mol %. The polyvinyl acetal resin having these properties may be used to manufacture a polyvinyl acetal film having sound insulation properties.

The polyvinyl acetal is prepared by acetalization of polyvinyl alcohol and the aldehyde.

According to one or more other embodiments, an interlayer for laminated glass may include a first layer having a first polyvinyl acetal, an aldehyde, and a plasticizer. The first layer may include the aldehyde and a reaction product derived from the aldehyde. The amount of an alkanoic acid comprised in the first layer may be 2.0 wt % or less with respect to a total amount of a reference material, and the total amount being the sum of the aldehyde and the reaction product of the aldehyde.

The amount of an alkanoic acid comprised in the first layer may be 1.0 wt % or less, 0.5 wt % or less, or about 0.00001 wt % to about 1.0 wt %, with respect to a total amount of a reference material, the total amount being the sum of the aldehyde and the reaction product of the aldehyde.

In a case in which the alkanoic acid is included in an amount within the above ranges, although the residual aldehyde is present, an interlayer for laminated glass which has excellent properties such as relatively low yellowness and high durability may be prepared.

The aldehyde is a reaction residue of the acetalization reaction, and as described above, may form various reaction products. The reaction products of the aldehyde may contain a carbonyl group or a hydroxyl group in molecules, and may comprise aldol condensation reaction products.

One of the reaction products may be alkanoic acid which is an acid material and has a formula represented by R₃COOH, wherein R₃ is methyl or ethylpentyl.

The aldehyde may include n-butanal, and the alkanoic acid may include 2-ethylhexanoic acid.

In this regard, a reference material of the amount of the alkanoic acid may include any one selected from the group consisting of the residual aldehyde and a reaction product thereof, for example, i) the n-butanal; ii) the 2-ethylhexanoic acid; iii) any one selected from the group consisting of 2-ethyl-2-hexanal, 2-ethylhexanal, and 2-ethylhexanol, and combinations thereof.

The 2-ethylhexanoic acid, the 2-ethyl-2-hexanal, the 2-ethylhexanal, or the 2-ethylhexanol may be derived from the residual n-butanal, and may be removed in the above-described post-treatment and film formation processes, and thus some materials may not be substantially detected within the prepared film.

The first layer may include about 58 to about 80 parts by weight of the first polyvinyl acetal and about 20 to about 42 parts by weight of the plasticizer.

The first layer may include about 60 to about 75 parts by weight of the first polyvinyl acetal and about 25 to about 40 parts by weight of the plasticizer. In this case, the first layer may serve as a skin layer, and may have excellent adhesion to a transparent laminated structure such as glass or the like and may also impart excellent mechanical strength to laminated glass or the like.

The interlayer may further include a second layer disposed on the first layer which comprises the second polyvinyl acetal and a plasticizer.

The second layer may include about 58 to about 69 parts by weight of the second polyvinyl acetal and about 31 to about 42 parts by weight of the plasticizer.

When the interlayer includes the second layer, the second layer may serve as a sound insulation layer, and the interlayer including the second layer may have excellent mechanical strength and excellent sound insulation performance.

The second polyvinyl acetal may have a weight average molecular weight of 400,000 Dalton or more, for example, about 490,000 to about 850,000 Dalton, about 610,000 to about 820,000 Dalton, or about 690,000 to about 790,000 Dalton.

When the weight average molecular weight of the second polyvinyl acetal is 400,000 or more, the interlayer may have enhanced mechanical and physical properties, and co-extrusion workability, miscibility of the composition, and the like may be further enhanced.

The interlayer for laminated glass may have a three-layered structure comprising a first layer/a second layer/a first layer.

The interlayer may further comprise a third layer disposed between the first layer and the second layer and comprising a third polyvinyl acetal and a plasticizer.

The third layer may comprise about 58 to about 80 parts by weight of the third polyvinyl acetal and about 20 to about 42 parts by weight of the plasticizer.

A hydroxyl content of the third polyvinyl acetal may have a value between the hydroxyl content of the first polyvinyl acetal and the hydroxyl content of the second polyvinyl acetal.

The interlayer for laminated glass may have a five-layered structure comprising a first layer/a third layer/a second layer/a third layer/a first layer.

When an interlayer for laminated glass, which has such a five-layered structure, is prepared, excellent sound insulation properties may be exhibited within a wider temperature range, and interlayer heterogeneity is reduced, and accordingly, an interlayer delamination phenomenon may be significantly reduced in an interlayer for laminated glass.

The interlayer for laminated glass may have a yellowness index of 3.0 or less, 2.5 or less, about 0.1 to about 2.5, or about 0.1 to about 1.5.

The yellowness index is based on measurement made in accordance with American Society for Testing and Materials, International ASTM E313-15e1. The interlayer having such a yellowness index has a considerably low yellowness index and may have excellent high transparency, excellent color characteristics, and excellent durability.

The interlayer for laminated glass may have a difference in yellowness index of less than 3 before and after an accelerated weathering test (based on 744 hours) by d−YI evaluation.

For example, the first layer may have a yellowness index of 3.0 or less, 2.5 or less, about 0.1 to about 2.5, or about 0.1 to about 1.5.

For example, the second layer may have a yellowness index of 3.0 or less, 2.5 or less, about 0.1 to about 2.5, or about 0.1 to about 1.5.

For example, the third layer may have a yellowness index of 3.0 or less, 2.5 or less, about 0.1 to about 2.5, or about 0.1 to about 1.5.

The first to third layers having the above-described characteristics may be prepared using respective polyvinyl alcohol resins having the alkanol amount characteristics as described above.

The plasticizer may be, for example, selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibutoxy ethoxy ethyl adipate (DBEA), butyl carbitol adipate (DBEEA), dibutyl sebacate (DBS), bis 2-hexyl adipate (DHA), and mixtures thereof. More particularly, triethylene glycol bis 2-ethylhexanoate (3G8) may be used as the plasticizer. The plasticizers applied to the respective layers may be identical or different.

The interlayer for laminated glass may further comprise an additive selected from the group consisting of an antioxidant, a heat stabilizer, a UV absorber, a UV stabilizer, an IR absorber, a glass adhesion regulator, and combinations thereof.

The additive may be comprised in at least one of the above-described first to third layers, and due to inclusion of the additive, long-term durability such as thermal stability and light stability and anti-scattering performance of the film may be enhanced.

The antioxidant may be a hindered amine-based antioxidant or a hindered phenol-based antioxidant. For example, the hindered phenol-based antioxidant may be used in view of a polyvinyl butyral (PVB) preparation process that requires a processing temperature of 150° C. or more. The hindered phenol-based antioxidant may be, for example, IRGANOX 1076, 1010 manufactured by BASF, and the like.

The heat stabilizer may be a phosphite-based heat stabilizer in consideration of compatibility with the antioxidant. For example, IRGAFOS 168 manufactured by BASF may be used as the heat stabilizer.

The UV absorber may be Chemisorb 12, Chemisorb 79, Chemisorb 74, or Chemisorb 102 that is manufactured by CHEMIPRO KASEI KAISHA LTD., or Tinuvin 328, Tinuvin 329, or Tinuvin 326 that is manufactured by BASF, or the like. The UV stabilizer may be Tinuvin manufactured by BASF, or the like. The IR absorber may be ITO, ATO, AZO, or the like. And the glass adhesion regulator may be a salt of a metal such as magnesium (Mg), potassium (K), sodium (Na), or the like, epoxy-based modified Si oil, a mixture thereof, or the like, but the present disclosure is not limited to the above examples.

The interlayer may have a total thickness of 0.4 mm or more, particularly about 0.4 mm to about 1.6 mm, about 0.5 mm to about 1.2 mm, or about 0.6 mm to about 0.9 mm. The above thickness ranges are suitable in view of minimum regulatory performance and cost.

The interlayer may consist of the first layer, or may comprise the first layer.

The second layer comprised in the interlayer may have a thickness of about 0.04 mm to about 0.20 mm, about 0.07 mm to about 0.18 mm, or about 0.09 mm to about 0.15 mm.

The third layer comprised in the interlayer may have a thickness of 0.3 mm or less, 0.1 mm or less, 0.09 mm or less, about 0.001 mm to about 0.1 mm, about 0.001 mm to about 0.08 mm, or about 0.001 mm to about 0.3 mm.

The interlayer with a total thickness of 800 μm which comprises the second layer may have a loss factor of 0.35 or more, measured at a temperature of 20° C. and a frequency ranging from 2,000 Hz to 4,000 Hz.

According to one or more other embodiments, laminated glass may include a laminated structure including a first glass disposed on a surface of the above-described interlayer for laminated glass; and a second glass disposed on the other surface of the interlayer for laminated glass.

The first glass and the second glass may refer to transparent plate-shaped glass, and a material such as light-transmitting plastic or the like may be partially or completely used in the first glass and the second glass.

The laminated glass may be used as glass of automobiles, interior materials or exterior materials of buildings, and the like, and has low yellowness and excellent durability.

Hereinafter, additional embodiments of the present disclosure will be described in further detail. In the following description of experiments, where the unit % is unclear whether it refers to wt % or mol %, means wt %.

1) Synthesis of Polyvinyl Acetal

Synthesis of Resin 1

30 g of polyvinyl alcohol (PVA) having a degree of polymerization of 1,700 and a degree of saponification of 99% was added to 570 g of distilled water at 90° C. to prepare a 5.00 wt % aqueous PVA solution and placed in a reactor. The temperature of the reactor was reduced down to 17° C., and then 38.57 g of hydrochloric acid with a purity of 37 mol % was added as a catalyst to the aqueous PVA solution, and while the temperature of the reactor was maintained at 50° C. to 55° C., 29.7 g of n-butanal was added in small amounts and PVB synthesis was performed for 3 hours.

After the PVB synthesis was sufficiently performed, the temperature of the reactor was reduced down to 20° C. and then neutralization was performed for 1 hour while sodium hydroxide (NaOH) was added in small amounts such that a pH reached 10, thereby obtaining a polyvinyl butanal (PVB) resin, which was solid resin 1.

Resin 1, i.e., the PVB resin, was washed using distilled water, and particularly washed five times with distilled water in an amount that was 10 times that of the PVB resin, and then dried with hot air to remove moisture therefrom, thereby obtaining powder-type resin 1.

Synthesis of Resin 2

Resin 1 prepared in the above synthesis of resin 1 was treated in a high-temperature and high-pressure container at 170° C. and 6 bara and in a H₂/N₂ reducing atmosphere for 5 hours, and then was washed with water, or the like, thereby completing the synthesis of resin 2.

Synthesis of Resin 3

Resin 1 prepared in the above synthesis of resin 1 was treated in a high-temperature and high-pressure container at 170° C. and 6 bara and in a H₂/N₂ reducing atmosphere for 10 hours, and then was washed with water, or the like, thereby completing the synthesis of resin 3.

2) Amount Ratio of Hexanol to Butanal in Resin

A relative amount of 2-ethylhexanol with respect to the amount of n-butanal in the sample was examined using thermal desorption-gas chromatograph/mass spectrometer (TD-GC/MS).

In particular, about 0.04 g of a resin powder sample was collected and allowed to pass through a first thermal desorption unit and a second thermal desorption unit in a TD system (JTD-505III, JAI). Temperature conditions were 150° C. (PAT, Priory Absorption Tube) and −40° C. (cold trap), PAT heating time was 15 minutes, and SAT (Secondary Absorption Tube) desorption time was 3 minutes. A split ratio was 1/50.

The sample having passed through the TD system was separated and detected through GC-MS. In particular, an Agilent 7890B (GC)/5977A (MS) detector equipped with a HP5MS column (0.25 mm×30 m×0.25 μm) was used in an experiment, and conditions of oven: 40° C. (5 min holding)-10° C./min-280° C. (5 min holding)-10° C./min-300° C. (9 min holding) were applied.

As a result of detection, target materials were detected between 2 minutes and 15 minutes, and particularly, n-butanal (RT2.58, RT refers to retention time), 2-ethylhexanal (RT10.87), 2-ethyl-2-hexenal (RT11.88), 2-ethylhexanol (RT12.49), and 2-ethylhexanoic acid (RT14.14) were identified, followed by peak integration, and the contents of 2-ethylhexanol and n-butanal were quantified in ppm and then a ratio of the contents of 2-ethylhexanol to n-butanal was confirmed (see Table 1 below).

3) Preparation of Polyvinyl Acetal Film

A total 100 wt % of a composition comprising 0.1 wt % of each of IRGANOX 1010 and IRGAFOS 168 as antioxidants, 0.03 wt % (30 ppm) of each of magnesium acetate and potassium acetate as adhesion regulators, 0.3 wt % of Tinuvin P as a UV blocking agent, 27.5 wt % of triethylene glycol bis 2-ethylhexanoate (3G8) as a plasticizer, and the remainder, resin 1 as a polyvinyl acetal resin was put into an extruder, extruded via a biaxial stretcher at 200° C., and then subjected to T-die casting, thereby obtaining sheets 1 to 3, which were single-layered interlayers having a thickness of 760 μm.

4) Hexanol Content to Butanal Content in Sheet

Analysis was performed in the same manner as in detection of amounts in a resin as described in the above 2), except that about 0.5 g of a sample was used in each sheet for analysis unlike the case of the resin.

Analysis results were obtained in the same manner as in the above 2), followed by peak integration, and then the amount of 2-ethylhexanoic acid was confirmed (see Table 1 below).

5) Quantitative Analysis of 2-EthylHexanoic Acid in Sheet

A butanal-derived reaction byproduct in a film for lamination was analyzed using TD-GC/MS. 0.5 g of each of films prepared according to examples and comparative examples was allowed to pass through a first thermal desorption unit and a second thermal desorption unit in a TD system (JTD-505III, JAI). Temperature conditions were 150° C. (PAT) and −40° C. (cold trap), PAT heating time was 15 minutes, and SAT desorption time was 3 minutes. A split ratio was 1/50.

The sample having passed through the TD system was separated and detected through GC-MS. In particular, an Agilent 7890B (GC)/5977A (MS) detector equipped with a HP5MS column (0.25 mm×30 m×0.25 μm) was used in an experiment, and conditions of oven: 40° C. (5 min holding)-10° C./min-280° C. (5 min holding)-10° C./min-300° C. (9 min holding) were applied.

Quantitative analysis was performed on 2-ethylhexanoic acid (RT14.14) as a target material by using a Flame Ionization Detector (FID) detector. First, standard samples prepared by dissolving 2-ethylhexanol were made at three concentrations: 439 ppm, 1,131 ppm, and 2,695 ppm, quantitative analysis was performed thereon, and a calibration curve was obtained by denoting the y axis as added amount and the x axis as peak area and used as a reference material.

Relative quantification was performed on n-butanal (RT2.58) and reaction products thereof, i.e., 2-ethylhexanal (RT10.87), 2-ethyl-2-hexenal (RT11.88), and 2-ethylhexanoic acid (RT14.14), based on the calibration curve of 2-ethyl-hexanol, and calculation results obtained using the calculated values are shown in Table 1 below.

6) Color Evaluation of Sheets (Y.I., Yellowness Index)

Yellowness indexes (Y.I.) of polyvinyl acetal films (sheets 1 to 3) were measured in accordance with ASTM E313. In particular, a release film, each sheet, and a release film (silicon-coated PET) were laminated in a laminator through heating and pressing at 150° C. for 15 minutes to fabricate a specimen having a laminated structure of release film/sheet/release film, and the release films were removed from each specimen, and then measurement was performed thereon using a measurement device manufactured by HUNTER-LAB under conditions of 400 nm to 800 nm, and results thereof are shown in Table 1 below.

7) Durability Evaluation of Sheets

D-YI Evaluation Method

An accelerated weathering test of laminated glass was performed in accordance with KS M ISO 4892-3:2002 and durability was evaluated based on d−YI (difference in yellowness index).

Glass having an area of 70 mm×150 mm and a thickness of 2.1 mm and each of sheets 1 to 3 were used to manufacture a laminated structure of glass/interlayer/glass, and pre-lamination and lamination were performed thereon. A yellowness index initial value (YIᵢₙᵢₜᵢₐₗ) of the center of each specimen in a laminated state was measured using a measuring device manufactured by HUNTER LAB according to the ASTM E313 standard. Each specimen in which initial value measurement had been completed was placed in QUV™ equipment and was subjected to an accelerated weathering test for 744 hours. A yellowness index final value (YI_{final}) of the center of each test-completed specimen was measured and a difference in yellowness index was obtained by the following Equation:

d−YI=YI_{final}−YIᵢₙᵢₜᵢₐₗ.

For the obtained values, when d−YI was 3 or more, the case was evaluated as FAIL, and when d−YI was less than 3, the case was evaluated as PASS, and the results thereof are shown in Table 1 below.

8) Evaluation of Penetration Resistance and Impact Resistance of Sheets

Penetration Resistance Evaluation

Penetration resistance of each of the laminated glasses was evaluated in accordance with KS L 2007.

Glass having an area of 300 mm×300 mm and a thickness of 2.1 mm and each of sheets 1 to 3 as interlayers were used to manufacture a laminated structure of glass/interlayer/glass, followed by pre-lamination in a vacuum, degassing, and edge sealing. Subsequently, lamination was performed on each laminated structure using an autoclave at 150° C. for 2 hours to prepare a specimen. Thereafter, a 2.26 kg steel ball was dropped on each specimen to measure a height (MBH) at which the specimen was penetrated. For measurement results, a case, in which each specimen was penetrated from a height of less than 4 m, was denoted as Fail, and a case, in which each specimen was penetrated from a height of 4 m or more, was denoted as Pass.

Impact Resistance Evaluation

It was evaluated in accordance with KS L 2007:2008 whether some of each laminated glass was missing or not during impact resistance evaluation.

A process of preparing a laminated structure of glass/interlayer/glass using glass having a thickness of 2.1 mm and each of sheets 1 to 3 as interlayers and laminating the structure was performed in the same manner as in the above penetration resistance evaluation.

For low-temperature evaluation, a 227 g steel ball was stored at −20° C. for 4 hours and then was dropped from a height of 9 m, and a case, in which the amount of glass that was scattered or separated from each sheet due to breakage of each impacted specimen was 15 g or more, was denoted as Fail, and a case in which the amount of glass that was scattered or separated from each sheet due to breakage of each impacted specimen was less than 15 g, was denoted as Pass.

For room-temperature evaluation, a 227 g steel ball was stored at 40° C. for 4 hours and then was dropped from a height of 10 m, and a case, in which the amount of glass that was scattered or separated from each sheet due to breakage of each impacted specimen was 15 g or more, was denoted as Fail, and a case in which the amount of glass that was scattered or separated from each sheet due to breakage of each impacted specimen was less than 15 g, was denoted as Pass.

TABLE 1

| | Resin 1/ | Resin 1/ | |
|---|---|---|---|
| Product | Sheet 1 | Sheet 2 | Resin 1/Sheet 3 |
| Ratio of n-butanal:2-ethylhexanol in | 100:17 | 100:55 | 100:81 |
| resin (parts by weight) | | | |
| Amount of 2-ethylhexanoic acid in | 3.00 | 0.70 | 0.20 |
| reference materials (n-butanal and | | | |
| reaction products thereof) (wt %) | | | |
| Color of Sheet (YI) | 6.2 | 2.1 | 1.1 |
| Durability of Sheet (d-YI) | fail | pass | pass |
| Penetration Resistance | pass | pass | pass |
| Impact resistance (low temperature) | pass | pass | pass |
| Impact resistance (room | pass | pass | pass |
| temperature) | | | |

*N-butanal and reaction products thereof refer to n-butanal remaining after resin preparation and materials derived therefrom, and particularly refer to n-butanal (RT2.58), 2-ethylhexanal (RT10.87), 2-ethyl-2-hexenal (RT11.88), 2-ethylhexanol (RT12.49), and 2-ethylhexanoic acid (RT14.14).

Referring to the results of Table 1, resin 1 is evaluated as polyvinyl butyral having a relatively high content of n-butanal, in which the content of 2-ethylhexanol is relatively low with respect to that of n-butanal in resin 1. In contrast, resin 2 and resin 3 are polyvinyl butyral having a relatively low content of n-butanal, in which the content (parts by weight) of 2-ethylhexanol is 50 or more with respect to 100 parts by weight of n-butanal.

As described above, n-butanal is modified in a reaction process and as a result, 2-ethylhexanal is generated as a byproduct, and 2-ethylhexanol is generated by reduction of 2-ethylhexanal or 2-ethylhexanoic acid is generated by oxidation of 2-ethylhexanal.

2-ethylhexanoic acid comprised in a relatively large amount in sheet 1 prepared using resin 1 is not only an environmentally harmful material, but is also a material with high acidity, and thus is considered to affect yellowness, durability, and the like of the sheet.

Sheets 2 and 3 prepared using resins 2 and 3, respectively, comprise a relatively small amount of 2-ethylhexanoic acid, which is considered to be due to the fact that a considerable amount of n-butanal comprised in resin 1 is reduced into 2-ethylhexanol through a reducing process applied to resin 1, and thus 2-ethylhexanol is removed into the air in a sheet preparation process, and the prepared sheet overall has a significantly small amount of 2-ethylhexanoic acid.

As is apparent from the foregoing description, one or more embodiments provide a polyvinyl acetal resin composition and laminated glass having an interlayer, which comprises the polyvinyl acetal resin composition. The one or more embodiments of the polyvinyl acetal resin composition can provide a composition for preparing a polyvinyl acetal interlayer, in which a yellowing phenomenon does not substantially occur and durability is enhanced.

While specific examples and embodiments have been described above, it will be apparent after an understanding of the disclosure of this application that various changes in form and details may be made in these examples and embodiments without departing from the spirit and scope of the claims and their equivalents. The examples and embodiments described herein are to be considered in a descriptive sense only, and not for purposes of limitation. Descriptions of features or aspects in each example and embodiment are to be considered as being applicable to similar features or aspects in other examples and embodiments. Suitable results may be achieved if the described techniques are performed in a different order, and/or if components in a described system, architecture, device, or composition are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A polyvinyl acetal resin composition comprising a polyvinyl acetal, an aldehyde, and an alkanol, wherein the alkanol is present in an amount of 50 parts by weight or more with respect to 100 parts by weight of the aldehyde.

2. The polyvinyl acetal resin composition of claim 1, wherein the aldehyde comprises n-butanal, and the alkanol comprises 2-ethylhexanol.

3. The polyvinyl acetal resin composition of claim 2, wherein the 2-ethylhexanol is present in an amount of about 0.5 to about 4 parts by weight, with respect to 1 part by weight of the n-butanal.

4. The polyvinyl acetal resin composition of claim 1, wherein the polyvinyl acetal is prepared by acetalization of polyvinyl alcohol and the aldehyde.

5. The polyvinyl acetal resin composition of claim 1, wherein the polyvinyl acetal is a first polyvinyl acetal comprising a hydroxyl content of 30 mol % or more and an acetyl content of less than 2 mol %.

6. The polyvinyl acetal resin composition of claim 5, wherein the hydroxyl content of the first polyvinyl acetal is in a range from about 30 mol % to about 50 mol %.

7. The polyvinyl acetal resin composition of claim 1, wherein the polyvinyl acetal is a second polyvinyl acetal comprising a hydroxyl content of 40 mol % or less and an acetyl content of 8 mol % or more.

8. The polyvinyl acetal resin composition of claim 7, wherein the hydroxyl content of the second polyvinyl acetal is in a range from about 1 mol % to about 10 mol %.

9. An interlayer for laminated glass, the interlayer comprising a first layer comprising a first polyvinyl acetal, an aldehyde, a reaction product derived from the aldehyde, and a plasticizer,
wherein the reaction product derived from the aldehyde comprises an alkanoic acid in an amount of 2.0 wt % or less with respect to a total amount of a reference material, which is the aldehyde and the reaction product of the aldehyde.

10. The interlayer of claim 9, wherein the first layer comprises an alkanol as the reaction product.

11. The interlayer of claim 9, wherein the first layer comprises a yellowness index of 3.0 or less, wherein the yellowness index is based on measurement made in accordance with ASTM E313-15e1.

12. The interlayer of claim 9, wherein the aldehyde comprises n-butanal, and the alkanoic acid comprises 2-ethylhexanoic acid.

13. The interlayer of claim 9, wherein the reference material comprises any one selected from the group consisting of i) n-butanal; ii) 2-ethylhexanoic acid; iii) any one selected from the group consisting of 2-ethyl-2-hexanal, 2-ethylhexanal, and 2-ethylhexanol; and combinations thereof.

14. A laminated glass comprising a laminated structure comprising: a first glass disposed on a surface of the interlayer according to claim 9 and a second glass disposed on another surface of the interlayer.

15. The laminated glass of claim 14, wherein the interlayer further comprises a second layer comprising a second polyvinyl acetal,
wherein the first polyvinyl acetal comprises a hydroxyl content of 30 mol % or more and an acetyl content of less than 2 mol %, and
wherein the second polyvinyl acetal comprises a hydroxyl content of 40 mol % or less and an acetyl content of 8 mol % or more.

16. A laminated glass, comprising:
an interlayer comprising a first layer;
a first glass disposed on a surface of the interlayer and a second glass disposed on an opposite surface of the interlayer,
wherein the first layer comprises a first polyvinyl acetal, an aldehyde, and an alkanol, wherein the alkanol is present in an amount of 50 parts by weight or more with respect to 100 parts by weight of the aldehyde.

17. The laminated glass of claim 16, wherein the aldehyde comprises n-butanal, and the alkanol comprises 2-ethylhexanol.

18. The laminated glass of claim 16, wherein the interlayer further comprises a second layer comprising a second polyvinyl acetal,
wherein the first polyvinyl acetal comprises a hydroxyl content of 30 mol % or more and an acetyl content of less than 2 mol %, and
wherein the second polyvinyl acetal comprises a hydroxyl content of 40 mol % or less and an acetyl content of 8 mol % or more.

19. The laminated glass of claim 18, wherein the interlayer further comprises a plasticizer and the first layer comprises about 58 to about 80 parts by weight of the first polyvinyl acetal and about 20 to about 42 parts by weight of the plasticizer, and
wherein the second layer comprises about 58 to about 69 parts by weight of the second polyvinyl acetal and about 31 to about 42 parts by weight of the plasticizer.

20. The laminated glass of claim 16, further comprising a difference in yellowness index d−YI of 3 or less, where YI_{final} is a yellowness index final value after an accelerated weathering test for at least 740 hours of the laminated glass performed in accordance with KS M ISO 4892-3:2002, YIᵢₙᵢₜᵢₐₗ is a yellowness index initial value before the weathering test, and d−YI=YI_{final}−YIᵢₙᵢₜᵢₐₗ,
wherein the yellowness indices YIᵢₙᵢₜᵢₐₗ and YI_{final} are measured in accordance with ASTM E313 standard.
